(19) United States
(12) Patent Application Publication
(10) Pub. No.: US 2010/0275754 A1
(43) Pub. Date: Nov. 4, 2010

(54) PUNCHING UNIT

(75) Inventors: Kazuo Nishimura, Ishikawa (JP); Toshiyuki Majima, Ishikawa (JP); Megumi Ichikawa, Ishikawa (JP); Susumu Ishii, Kanagawa (JP)

Correspondence Address: JORDAN AND HAMBURG LLP, 122 EAST 42ND STREET, SUITE 4000, NEW YORK, NY, 10168, US

(73) Assignee: Daido Kogyo Co Ltd, Ishikawa (JP)

(21) Appl. No.: 12/746,612

(22) PCT Filed: Dec. 5, 2008
(86) PCT No.: PCT/JP2008/072157

§ 371 Date: Jun. 7, 2010

(30) Foreign Application Priority Data
Dec. 5, 2007 (JP) 2007 314940

(51) Int. Cl. B26D 7/18; B26F 1/08

(52) U.S. Cl. 83/167; 83/495; 83/669

(57) ABSTRACT

There is provided a punching unit that is readily adjusted, is capable of always punching high quality holes through sheets and is steadily capable of discharging punch chips. A punch shaft and a die shaft are disposed vertically in parallel between side plates and these very punch shaft and the die shaft compose structural members (reinforcing members) of the punching unit. The die shaft has a die shaft body formed into a hollow cylinder and is provided with dies that correspond to the punches of the punch shaft at an outer peripheral surface thereof while fitting into die holes penetrating to the hollow section. A chip discharging screw plate fixed to the right side plate is disposed in the hollow section of the die shaft. Punch chips are transported along slopes of the chip discharging screw plate and discharged out of an opening when the die shaft rotates.

### CROSS REFERENCE TO RELATED APPLICATIONS

This application claims the foreign priority benefit under Title 35, United States Code §119(a)-(d) of Japanese Patent Application No. 2007-314940, filed on Dec. 5, 2007 in the Japan Patent Office, the disclosure of which is herein incorporated by reference in its entirety.

### BACKGROUND OF THE INVENTION

1. Field of the Invention

The present invention relates to a punching unit mounted in image forming apparatuses such as a copier and a printer for punching holes through sheets (such as sheets of papers) on which images have been recorded.

2. Related Art

Heretofore, there have been proposed punching units for punching holes through sheets by rotating a punch shaft and a die shaft disposed in parallel from each other and respectively having a plurality of punches and dies to engage the punches of the punch shaft with the dies of the die shaft as disclosed in Japanese Patent Application Laid-Open Nos. 2000-301492 and 2000-301494 for example.

The punch shaft and the die shaft are stored in a punch frame and a die frame respectively formed into integral cylinders having closed ends. The punch frame and die frame have been structural members (reinforcing members) of the punching unit. The die frame is provided with a punch chip discharging port at position corresponding to the die so that punch chips scraped out by a discharging bar naturally fall down and are discharged out of the punch chip discharging port.

Although it has been possible to reduce a number of parts and a number of assembling processes of the punching unit described above, as compared to what has been constructed by a punch frame and a die frame by assembling a large number of plate members, because the punch shaft and the die shaft have been stored in the punch frame and die frame that are integrally formed members, it has been difficult to align the punch and die and to adequately control an engaging clearance because the punch frame and die frame have been integrally formed.

It has been also difficult to fully assure rigidity of these punch shaft and die shaft, coupled with that an outer dimension of the punching unit is limited, so that there has been a case when the engaging clearance varies depending on a thickness of the sheets, thus punching inferior holes in quality. Still more, because the punching unit described above has required the punch frame and die frame having the closed section, a number of parts and an assembly time have increased by that much, causing an increase of the product cost.

Further, the punch chips scraped out by the discharging bar could not have been fully discharged by a method of discharging the punch chips out of the punch chip discharging port by leaving the natural fall.

Accordingly, the invention seeks to provide a punching unit that solves the aforementioned problems by arranging the very die shaft and punch shaft as structural members (reinforcing members) of the punching unit and by disposing a punch chip transporter within a hollow section formed in the die shaft.

### SUMMARY OF THE INVENTION

In order to solve the aforementioned problems, according to the invention, there is provided a punching unit including a punch shaft provided with a plurality of punches on the outer peripheral surface thereof and a die shaft having dies at positions corresponding to the punches and being arranged to punch holes through sheets by engaging the punches with the dies by rotating the punch and die shafts, wherein the punching unit further includes frames for supporting both ends of the punch and die shafts to form the very punch and die shafts as structural members of the punching unit, a hollow section formed substantially across the whole length the die shaft, a punch chip discharging port that penetrates through the die shaft from the hollow section to the outside of the die shaft, holes penetrating the die shaft from the outer peripheral surface to the hollow section thereof to provide the dies therein and a punch chip transporter provided in the hollow section for transporting the punch chips from the dies toward the punch chip discharging port.

Preferably, the punch shaft has a shape having a hollow section substantially across the whole length of the punch shaft and the punch and die shafts are formed of a light alloy metal.

Preferably, the punch chip transporter is constructed of a spiral guide. However, the spiral guide needs not be always continuous and may be constructed of a plurality of separate members.

For example, the guide may be a screw member fixed to the frame and is disposed substantially across the whole length of the hollow section of the die shaft and transports the punch chips by relative rotation of the screw member and the die shaft as shown in FIGS. 1 through 3 and FIG. 7A.

The guide may also have a screw structure disposed within the inner peripheral surface of the hollow section of the die shaft and transports the punch chips by rotating together with the die shaft as shown in FIGS. 4 and 7B for example.

Preferably, the guide may be a screw member disposed substantially across the whole length of the hollow section of the die shaft and is rotated and driven with a number of revolutions that is different from a number of revolutions of the die shaft as shown in FIGS. 5, 6 and 7C for example.

According to the invention described above, the frames support the both ends of the punch shaft and die shaft and the very punch shaft and die shaft compose the structural members (reinforcing members) of the punching unit and no die frame and punch frame that have been otherwise necessary in the past is required, so that the punch shaft and die shaft may be readily removed and an engaging clearance (alignment) may be readily controlled. Still more, diameters of the punch shaft and die shaft may be enlarged and rigidity thereof may be increased. It allows high quality punch holes to be perforated regardless of types of the sheets. Further, because the hollow section is formed in the die shaft and the punch chip transporter is provided in the hollow section to transport and discharge the punch chips, it becomes possible to prevent the punch chips from clogging within the die and die shaft and to discharge the punch chips to a predetermined place altogether without scattering.

Because the punch shaft has the hollow section substantially across the whole length of the punch shaft and the punch shaft and die shaft are formed of a light alloy metal, the punch shaft and die shaft may be structured in high rigidity while having a light weight, thus allowing the quality of punch holes to be improved and the speed of the punching unit to be increased.

Still more, because the punch chip transporter is composed of the spiral guide, the punch chips may be transported steadily by the slopes of the guide and discharged out of the discharging port.

Further, because the guide is composed of the screw member fixed to the frame, the punch chips may be steadily discharged by relatively rotating the die shaft and the screw member without providing a driving source dedicated only for the screw member.

Still more, because the guide is composed of the screw structure disposed within the inner peripheral surface of the die shaft and rotated in a body with the die shaft, the punch chips may be transported and discharged by the simple and compact configuration.

The punch chips may be also more steadily discharged by rotating and driving the guide composed of the screw member.

It is noted that the summary of the invention described above does not necessarily describe all necessary features of the invention. The invention may also be a sub-combination of the features described above.

### BRIEF DESCRIPTION OF THE DRAWINGS

FIG. 1 is a front view of a punching unit according to a first embodiment of the invention;

FIG. 2 is a plan view of the punching unit shown in FIG. 1;

FIG. 3 is a right side view of the punching unit shown in FIG. 1;

FIG. 4 is a front view of a punching unit according to a second embodiment of the invention;

FIG. 5 is a front view of a punching unit according to a third embodiment of the invention;

FIG. 6 is a plan view of the punching unit shown in FIG. 5; and

FIG. 7A is a left side view of the punching unit shown in FIG. 1, FIG. 7B is a left side view of the punching unit shown in FIG. 4 and FIG. 7C is a left side view of the punching unit shown in FIG. 5.

### DETAILED DESCRIPTION OF THE INVENTION

The invention will now be described based on preferred embodiments, which do not intend to limit the scope of the invention, but exemplify the invention. All of the features and the combinations thereof described in the embodiments are not necessarily essential to the invention.

A punching unit of the invention will be explained below with reference to the drawings.

### First Embodiment

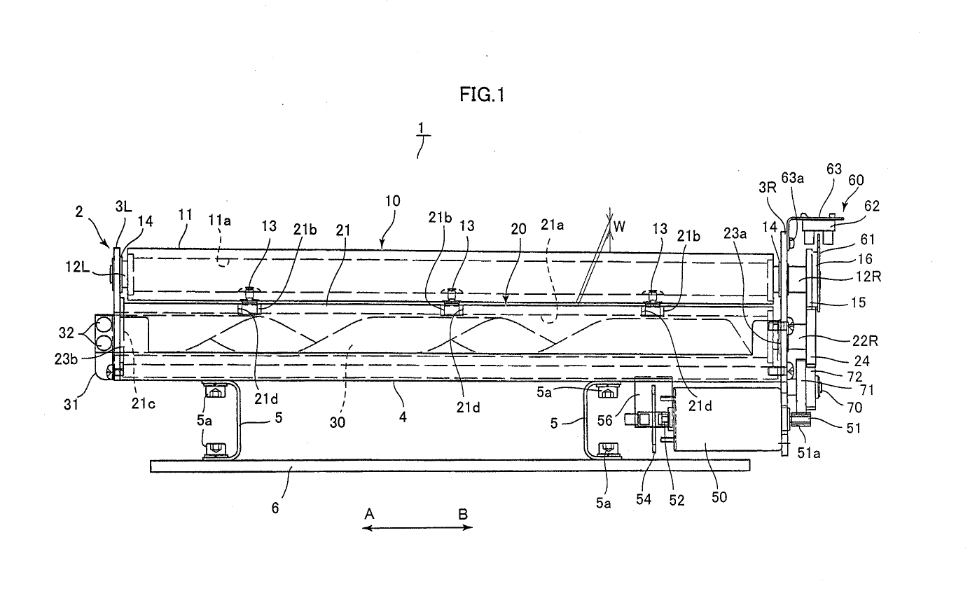

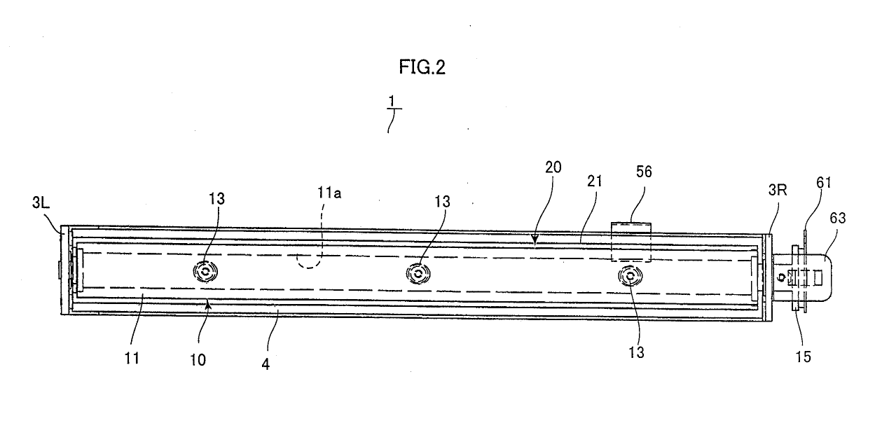

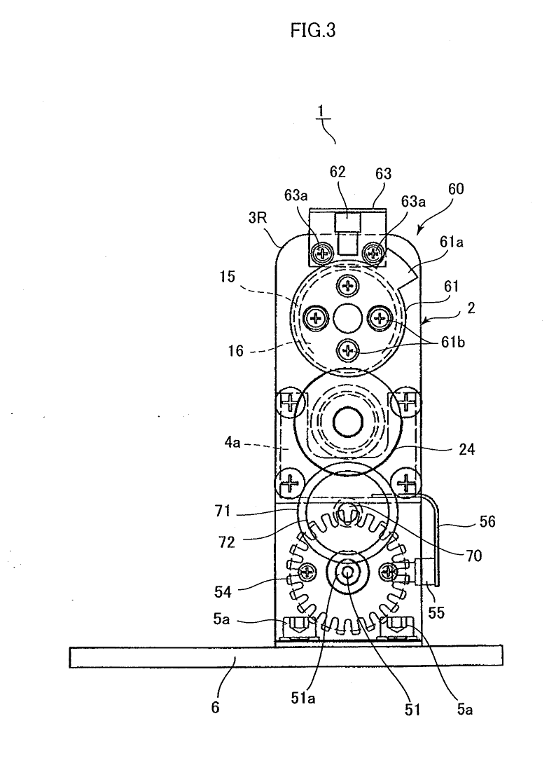

FIG. 1 is a front view, FIG. 2 is a plan view and FIG. 3 is a right side view of the punching unit 1 according to a first embodiment of the invention. As shown in FIGS. 1 through 3, the punching unit 1 has a pedestal 6 that is to be fixed to a frame of an image forming apparatus (having a post-processing device) such as a printer. The pedestal 6 is provided with a bottom plate 4 fixed thereto by bolts 5a through legs 5. The bottom plate 4 is provided with right and left side plates 3R and 3L on right and left ends thereof. A frame 2 is composed of the bottom plate 4 and the side plates 3R and 3L combined in a body. The side plates 3R and 3L support a punch shaft 10 and a die shaft 20 disposed in parallel between them so as to be rotatable. Together with the frame 2 described above, the punch shaft 10 and the die shaft 20 compose structural members (reinforcing members) of the punching unit 1. It is noted that the side plates 3R and 3L support the punch shaft 10 and die shaft 20 while leaving a predetermined gap W that becomes an engaging clearance through which sheets pass.

The punch shaft 10 is composed of a punch shaft body 11 composed of a hollow cylindrical member made of a light alloy metal such as aluminum alloy and a punch axial sections (not shown) provided on both side ends of the punch shaft body 11. The punch shaft body 11 is provided with a plurality of, e.g., three, punches 13 in an axial direction (a direction of an arrows A and B in FIG. 1) thereof in a hollow section 11a within the cylinder so that the punches 13 project out of an outer peripheral surface of the cylinder while being retained.

The punch axial sections are attached so as to close openings of the sides of the punch shaft body 11. The punch axial sections are provided with bosses 12R and 12L of a punch gear 15 and others fitted into them and are rotatably supported by the side plates 3R and 3L through bearings 14. As described above, the punch axial section in the direction of the arrow B in FIG. 1 (the direction of the arrow A in FIG. 1 will be defined as a left direction and the direction of the arrow B as a right direction in FIG. 1) is fixedly provided with the punch gear 15 for transmitting driving force to the punch shaft 10 and a backlash removing gear 16 adjoining to the punch gear 15 is provided with a detecting plate 61 composing a punching position detecting device 60 attached thereto with screws 61b.

As shown in detail in FIG. 3, the punching position detecting device 60 is composed of the detecting plate 61 and a punching position detecting sensor 62, i.e., a photo sensor, that is attached to a L-shaped bracket 63 fixed to an upper part of the right side plate 3R with screws 63a. The detecting plate 61 is provided with a detector 61a for detecting that the punch 13 is located in punching position when the detector 61a passes through the punching position detecting sensor 62.

Meanwhile, the die shaft 20 is also made of a light alloy metal such as aluminum alloy similarly to the punch shaft 10 and has a die shaft body 21 composed of a hollow cylindrical member. The die shaft body 21 is provided with three dies 21b at an outer periphery thereof in an axial direction (in the direction of the arrows A and B in FIG. 1) in correspondence to the punches 13 of the punch shaft 10. The die 21b is formed so as to fit into a die hole 21d that penetrates through the die shaft body 21 from the outer peripheral surface to a hollow section 21a thereof.

The right side plate 3R rotatably supports a right die axial section (not shown) provided on the right side end part of the die shaft body 21 through a bearing 23a and a boss portion 22R of a die gear 24 that transmits driving force to the die shaft 20 and engages with the punch gear 15 is inserted into the right die axial section. A left die axial section 22L is also inserted into and is rotatably supported by the left side plate 3L through a bearing 23b on a left side end part of the die shaft body 21.

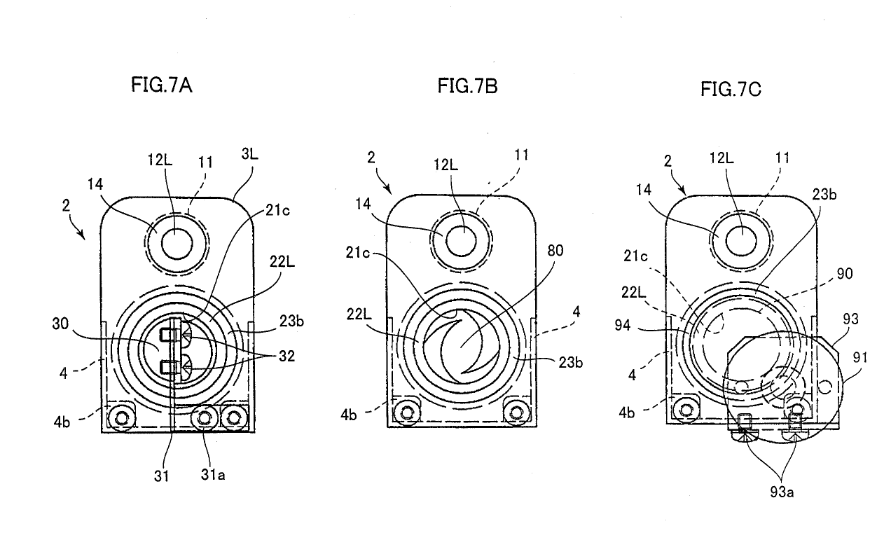

As shown in FIG. 7A, the left die axial section 22L is provided with an opening 21c that is formed at a center thereof and communicates with the hollow section 21a of the die shaft body 21. An attachment bracket 31 is attached to an outside of the left side plate 3L with screws 31a and is fixedly provided with a chip discharging screw plate (guide or screw member) 30 that is a punch chip transporter with screws 32.

The chip discharging screw plate 30 is composed of a guide, i.e., a plate member formed in spiral, and is disposed through the opening 21c of the left die axial section 22L and substantially across the whole length of the hollow section 21a of the die shaft body 21 in a direction from the arrow A to the arrow B in FIG. 1. That is, the chip discharging screw plate 30 is arranged so as to forcibly transport punch chips along slopes of the chip discharging screw plate 30 when the die shaft 20 is rotated. Then, the punch chips are transported and are discharged out of a punch chip discharging port composed of the opening 21c formed on the left end part of the die shaft 20 without scattering.

It is noted that although the chip discharging screw plate 30 is preferred to be a metal such as a steel plate and an aluminum alloy, it may be made of plastics or of rubber. Still more, the chip discharging screw plate 30 needs not be the plate member but may be a bar-like member formed in spiral such as a coil spring. Still more, there may be provided punch chip discharging ports on both right and left ends of the die shaft 20 to discharge punch chips out of these both punch chip discharging ports by forming such chip discharging screw plate 30 whose twisting directions are opposite on the right and left or forming two screw plates whose twisting direction is opposite.

The bottom plate 4 is formed into a shape of U in section so as to cover a lower half portion of the die shaft 20 as shown in FIGS. 3 and 7A and a right end thereof is bent into a shape of a flange. The flange 4a is secured to the right side plate 3R by screws and a flange 4b formed in a corner of the left end is secured to the left side plate 3L, thus forming the integral frame 2.

It is noted that although not shown, a punch chip box is removably attached to the bottom plate 4 at the position corresponding to the die shaft body 21 and collects the punch chips transported by the chip discharging screw plate 30.

Meanwhile, a bi-axial type electric motor 50 for driving the punching unit 1 is mounted in a lower end part of the right side plate 3R. A second output shaft 52 of the motor 50 provided on the side of the arrow A in FIG. 1 is fixedly provided with a detector 54 as shown in FIG. 3 and a pickup sensor 55 attached to a plate 56 extended from the bottom plate 4 detects a number of revolutions of the electric motor 50 by detecting variations of voltage corresponding to patterned indents of the detector 54.

A first output shaft 51 provided on the side of the arrow B in FIG. 1 is fixedly provided with an output gear 51a that engages with an intermediate gear 71 rotatably fitted into an intermediary shaft 70 projecting out of the right side plate 3R. The intermediate gear 71 is provided integrally with a transmission gear 72 by a pin or the like and the transmission gear 72 is engaged with the die gear 24 described above.

As described above, the die gear 24 of the die shaft 20 engages with the punch gear 15 of the punch shaft 10 and thereby, the driving force from the electric motor 50 is transmitted to the die shaft 20 and the punch shaft 10 via the intermediate gear 71 and the transmission gear 72.

Next, operations of the punching unit of the first embodiment of the invention will be explained. The punching unit 1 controls the revolution of the electric motor 50 by detecting the number of revolutions thereof and position of the punch 13 by the pickup sensor 55 and the punching position detecting device 60. Thereby, the punch shaft 10 and the die shaft 20 rotate in conformity with timing when the sheets on which images have been formed are conveyed to the engaging clearance W from the image forming apparatus to engage the punch 13 with the die 21b at adequate position of the sheets to punch holes.

When the sheets are punched by the punch 13 and the die 21b, the punch chips fall into the hollow section 21a of the die shaft body 21 by passing through the die 21b and the die hole 21d. The chip discharging screw plate 30 whose diameter is substantially the same with an inner diameter of the hollow section 21a and which is fixed to the bracket 31 of the left side plate 3L is inserted into the hollow section 21a, so that the chip discharging screw plate 30 and the die shaft 20 relatively rotate when the die shaft 20 is rotated to punch holes.

Thereby, the punch chips fallen into the hollow section 21a are transported along the slopes of the chip discharging screw plate 30 and arrive at the end of the die shaft 20. Then the punch chips are discharged out of the opening 21c and are collected by the punch chip box attached so as to communicate with the under part of the opening 21c. When a certain amount of punch chips accumulates in the punch chip box, a user removes the punch chip box to dump the punch chips. It is noted that the punch chip box may be disposed outside of the image forming apparatus and the punch chips may be guided thereto from the opening 21c by a duct.

The punching unit 1 is constructed as described above, so that the punch shaft 10 and the die shaft 20 may be formed large and their rigidity may be enhanced without requiring no punch frame and die frame for storing the punch shaft 10 and the die shaft 20 and can always perforate high quality punch holes regardless of types of the sheets. Still more, because the punch shaft 10 and the die shaft 20 may be readily removed, the engaging clearance may be adequately controlled by readily aligning the punch 13 with the die 21b. Further, because a number of parts is reduced, the punching unit 1 may be readily assembled and a manufacturing cost thereof may be also reduced.

Still more, because the chip discharging screw plate 30 fixed to the bracket 31 of the left side plate 3L is disposed in the hollow section 21a of the die shaft body 21, no driving source for separately rotating the chip discharging screw plate 30 is required, the punch chips may be steadily transported by relatively rotating the die shaft 20 and the chip discharging screw plate 30 and may be discharged out of the opening 21c without scattering.

### Second Embodiment

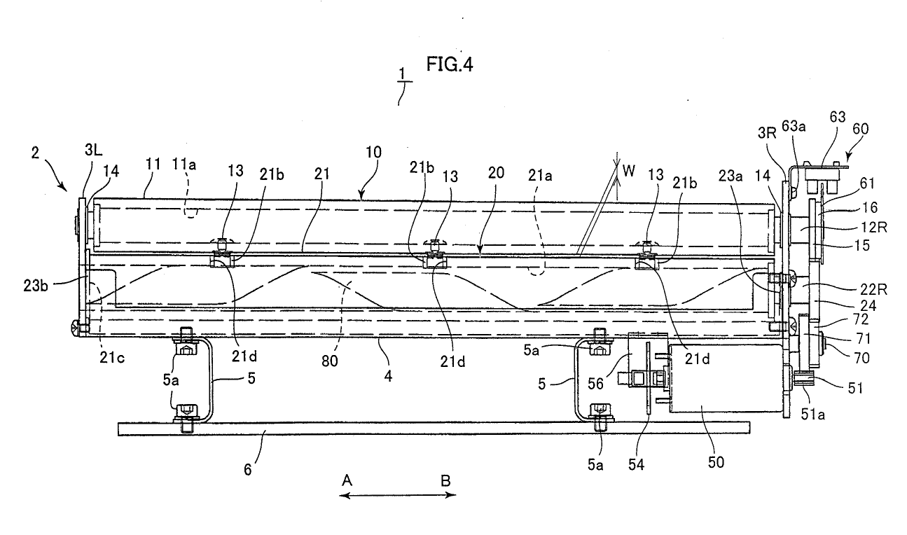

FIGS. 4 and 7B shows a punching unit of a second embodiment of the invention. This embodiment is what the punch chip discharging screw plate 30 fixed in the first embodiment is substituted with a round rod formed so as to have spiral blades and is disposed integrally with the hollow section 21a of the die shaft 20. The parts different from the structure of the first embodiment will be explained below.

As shown in FIGS. 4 and 7A, a chip discharging screw rod 80 (guide or screw structure), i.e., a punch chip transporter, is a round rod formed so as to have the spiral blades and is attached integrally and fittingly within the hollow section 21a of the die shaft body 21. Therefore, when the die shaft 20 rotates, the chip discharging screw rod 80 rotates in a body with the inner peripheral surface of the hollow section 21a of the die shaft body 21 and the punch chips are discharged out of the opening 21c along the slopes of the blades of the chip discharging screw rod 80 based on Archimedes' principle of a pump. That is, gravity acts on the punch chips and the punch chips tend to accumulate in the lower part of the hollow section 21a of the die shaft 20. When the die shaft 20 rotates together with the chip discharging screw rod 80, the punch chips on which the force of accumulating in the lower part is acting rotate relatively with the die shaft 20 and are transported in one direction by the chip discharging screw rod 80.

It is noted that the screw structure arranged integrally with the hollow section 21a of the die shaft body is not limited to be the chip discharging screw rod 80 and may be a screw member projecting into the hollow section 21a like ribs or rib-like projections or a concave groove formed integrally within the hollow section. Still more, the angle of the slopes thereof may be moderate. Still more, the discharge structure may be a slope extending obliquely across the whole length of the hollow section or may have two slopes whose angles of slopes are reversed from each other may be what the slope is split into a plurality of slopes.

That is, the screw structure integral with the die shaft 20 needs not be always a separate member from the die shaft 20 and needs not be always formed continuously. Still more, the slope may be a short slope below one spire and even this case will be defined as a spiral or screw member (screw structure) in the present invention.

Thus, the punch chips are steadily discharged and the punching unit 1 may be configured simple and compact because the chip discharging screw rod 80 is stored in the hollow section 21a of the die shaft body 21.

### Third Embodiment

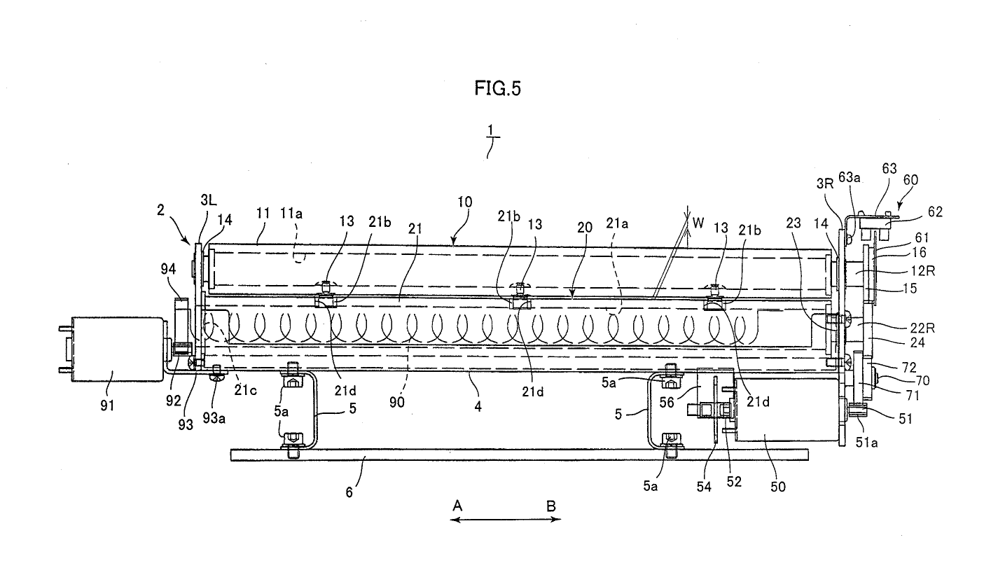

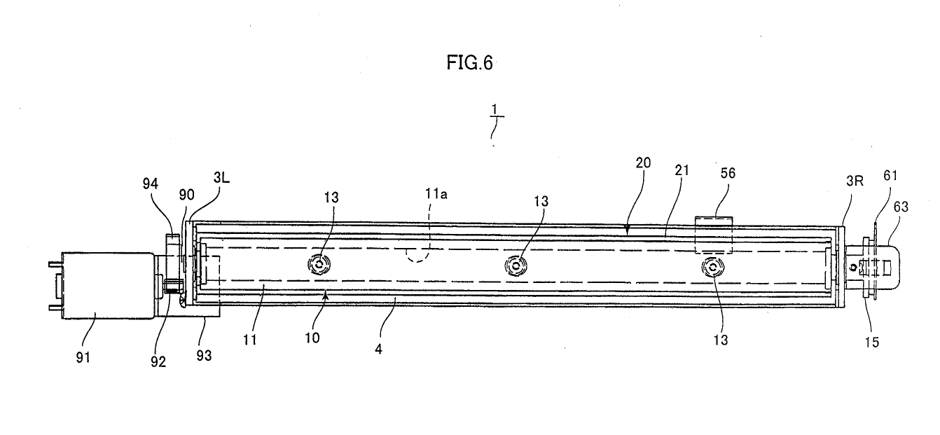

FIGS. 5, 6 and 7C shows a third embodiment of the invention. This embodiment is what the chip discharging screw plate 30 fixed in the first embodiment is modified into a coil-like member and the coil-like member is driven by the motor. The parts different from the structure of the first embodiment will be explained below.

As shown in FIGS. 5, 6 and 7C, a punch chip discharge coil (guide or screw member) 90, i.e., the punch chip transporter, is formed by winding a metal wire or a plastic flexible member into a cylindrical shape and a driving gear 94 is attached to one end thereof. The chip discharging coil 90 is disposed within the hollow section 21a of the die shaft body 21 in the direction from the arrow A to the arrow B in FIG. 5 and the driving gear 94 is rotatably supported by the side portion of the left side plate 3L.

The bottom plate 4 under the left side plate 3L is provided with a bracket 93 attached thereto by screws 93a to hold a chip discharging motor 91 for the chip discharging coil 90. An output gear 92 secured to an output shaft of the chip discharging motor 91 engages with the driving gear 94 of the chip discharging coil 90.

Thereby, the punching unit 1 may punch holes through the sheets by rotating the punch shaft 10 and the die shaft 20 by the electric motor 50 and in the same time, may transport and discharge the punch chips out of the opening 21c efficiently and steadily by relatively rotating the chip discharging coil 90 and the die shaft 20 by rotating the chip discharging coil 90 by the chip discharging motor 91.

It is noted that although the guide is desirable to be one that extends across the whole length of the hollow section in spiral, the invention is not limited to that and other transporter such as a belt may be used. Still more, the guide may have another shape like one in which a wavelike brush is attached to a linear rod or one in which a brush is attached obliquely in spiral, other than those described above like one in which the plate member is formed in spiral (the chip discharging screw plate 30), one in which the round rod is formed so as to have the spiral blades (the chip discharging screw rod 80) and one formed into the shape of a coil (the chip discharging coil 90). Still more, the spiral or screw do not always have a plurality of turns, but include a slope below one turn.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

What is claimed is:

1. A punching unit, comprising:
a punch shaft provided with a plurality of punches on the outer peripheral surface thereof and
a die shaft having dies at positions corresponding to said punches;
said punching unit being arranged to punch holes through sheets by engaging said punches with said dies by rotating said punch and die shafts;
said punching unit further comprising:
frames for supporting both ends of said punch and die shafts to form said very punch and die shafts as structural members of said punching unit;
a hollow section formed substantially across the whole length said die shaft;
a punch chip discharging port that penetrates through said die shaft from said hollow section to the outside of said die shaft;
holes penetrating through said die shaft from the outer peripheral surface to said hollow section thereof to provide said dies therein; and
a punch chip transporter provided in said hollow section for transporting the punch chips from said dies toward said punch chip discharging port.

2. The punching unit as set forth in claim 1,
wherein said punch shaft has a shape having a hollow section substantially across the whole length thereof; and
said punch and die shafts are formed of a light alloy metal.

3. The punching unit as set forth in claim 1,
wherein said punch chip transporter is constructed of a spiral guide.

4. The punching unit as set forth in claim 3,
wherein said guide is a screw member secured to said frame and is disposed substantially across the whole length of said hollow section of said die shaft and transports the punch chips by relative rotation of said screw member and said die shaft.

5. The punching unit as set forth in claim 3,
wherein said guide has a screw structure disposed within the inner peripheral surface of said hollow section of said die shaft and transports the punch chips by rotating together with said die shaft.

6. The punching unit as set forth in claim 3,
wherein said guide is a screw member disposed substantially across the whole length of said hollow section of said die shaft and is rotated and driven with a number of revolutions that is different from a number of revolutions of said die shaft.
